(19) United States
(12) Patent Application Publication
(10) Pub. No.: US 2020/0074971 A1
(43) Pub. Date: Mar. 5, 2020

(54) SOUND AND PROTECTIVE ABSORBER UNIT AND METHODS OF MAKING SAME

(71) Applicant: David Rothschild Company, Columbus, GA (US)

(72) Inventor: Walter G. Rothschild, Winston-Salem, NC (US)

(21) Appl. No.: 16/554,941

(22) Filed: Aug. 29, 2019

Related U.S. Application Data
(60) Provisional application No. 62/724,342, filed on Aug. 29, 2018.

(51) Int. Cl. G10K 11/162

(52) U.S. Cl. CPC G10K 11/162

(57) ABSTRACT

Disclosed is an inexpensive, yet efficient sound absorber or protective absorber unit that can be hung in the ceilings of public buildings, sound studios, and the like. Also disclosed are methods of making and using such sound absorber and protective absorber units.

### RELATED APPLICATIONS

This application claims priority to U.S. Provisional Patent Application No. 62/724,342, filed Aug. 29, 2018. The disclosure of U.S. Provisional Patent Application No. 62/724,342 is incorporated by reference in its entirety herein.

### INTRODUCTION

Many restaurants, bars, auditoriums, and public buildings suffer from excessive noise because the sound bounces and reverberates off the hard surfaces including floors, walls, and ceilings. Existing sound absorbers are typically expensive wall decorations and not absorbent enough to efficiently reduce the noise. Acoustical ceiling tiles in a hung ceiling are not particularly effective because there is not enough surface area possible in a horizontal ceiling. Many public places have open ceiling with exposed steel girders, pipes, and the like that are visible high in the ceiling and in in such settings, acoustical ceiling tiles are not used. Thus, there is a need for an inexpensive and effective method of dampening sound inside of public buildings.

Similarly, in certain situations there can be a need to protect individuals from the threat of ballistic attacks and or other types of danger. As such, there is a need for units that can function in this capacity, either as clothing articles or protective units to be hung or emplaced in a space.

### SUMMARY

Disclosed is a sound absorber unit and method of making same. In one embodiment, disclosed is a sound absorber unit comprising a sound absorber material that is encased in cloth.

The cloth may be woven. In certain embodiments, the unit is fabricated to hang from a support (e.g., a rod or ceiling support). In certain embodiments, the sound absorber material may be mineral wool, polymer foam, fiberglass, or any other material that can be used to absorb sound. In certain embodiments, the unit may further comprise a support structure, such as a rod or other support structures. In an embodiment, the cloth is a fabric, such as the type of fabric used on furniture or as a wall hanging.

Also disclosed is a protective absorber unit and method of making same. In one embodiment, the unit comprises a material that is impermeable to a projectile (e.g., a bullet, shrapnel or knife). For example, in certain embodiments the units may be filled with anti-ballistic materials or explosion shield materials, instead of sound absorbing materials, for use in military and law enforcement applications. The protective absorber unit may be encased in cloth. The cloth may be woven. In certain embodiments, the protective material may be bullet-proof material. In certain embodiments, the unit may further comprise a support structure, such as a rod or other support structure.

Further disclosed is a method for making such a sound absorber and/or protective absorber unit. The method may comprise the step of : (a) obtaining a sound absorber or protective absorber material; (b) encasing the sound absorber or protective material in an encasement material such that the material is substantially evenly distributed within the inner volume of the encasement material; and (c) closing any openings in the encasement material such that the sound absorber material is completely encased in the encasement material. In an embodiment, the encasement material is woven with pockets to house at least one support structure (e.g., a rod that extends across the horizontal width of the unit) and the sound absorbing or protective material. In an embodiment, the encasement material is configured to comprise at least two layers that are sealed together along each edge and that are configured to form a first inner pocket that comprises greater than 50% of the inner volume and optionally, at least one second inner pocket suitable for insertion of a support structure. In certain embodiments the method of making comprises the steps of: (i), weaving an encasement material with a first pocket for insertion of the sound absorber or protective absorber material and an second optional inner pocket for insertion of a support structure and having the inside surfaces facing outward; (ii) cutting one edge of the encasement material to allow access to the first inner pocket and the at least one second inner pocket; (iii) reversing the encasement material so that the outside surfaces are facing out; (iv) emplacing the sound absorber or protective material in the first pocket; (v) optionally, emplacing at least one support structure in the at least one second inner pocket; and (vi) sealing the open end of the encasement material such that the at least one support structure and the sound absorbing or protective material is completely enclosed in the first and at least one second inner pocket, respectively. In certain embodiments where the unit is a hanging, at least one hook or other hanging element may be inserted through encasement material in such a manner as to encircle at least in part the support structure.

Also disclosed is a method for reducing sound in a defined space by hanging a fabric encased sound absorber from the ceiling or on the walls. Also disclosed is a method for reducing the impact of a ballistic attack, shooting or other threats in a defined space by hanging a fabric encased protective absorber from the ceiling or on the walls.

### BRIEF DESCRIPTION OF THE DRAWINGS

The disclosure may be better understood by reference to the following non-limiting drawings.

FIG. 1 shows two different embodiments of a sound or protective absorber unit of the disclosure made to function as a hanging. One of the units (upper) has hooks only on the upper edge, whereas the other unit (lower) has hooks on both the upper and lower edge.

FIG. 2 shows an embodiment of a sound or protective absorber unit of the disclosure hanging via hooks attached to the unit from an external support.

FIG. 3 shows embodiment of a sound or protective absorber unit of the disclosure with an internal pocket housing an internal support structure that engages the hooks which allow for the unit to be hung from an external support structure.

FIG. 4 shows an embodiment of encasement material fabric woven as two units. In the embodiment shown in the figure, the inner surfaces are exposed (i.e., facing outward).

FIG. 5 shows an embodiment of encasement material that has been cut along at least two of the four edges to provide a single unit having exposed pockets for the insertion of sound absorber material or protective absorber material and inner support structures. In the embodiment shown in the figure, the inner surfaces are exposed (i.e., facing outward).

FIG. 6 shows the unit of FIG. 5 reversed to have the outside surfaces facing outward, the inner pockets filled with sound or protective absorbing material and one support structure and the edges closed (e.g., sealed).

FIG. 7 shows a sound absorber hanging of the disclosure in a hanging position in accordance with an embodiment of the disclosure. It can be seen that there are fasteners (i.e., hooks) positioned along the top edge.

FIG. 8 shows a close up view of a hook inserted into a sound absorber hanging in accordance with an embodiment of the disclosure. The supportive structure (i.e. a rigid rod not seen in the photo) is inside of the unit and extends through the hook such that it supports the hook when the sound absorber is hanging.

FIG. 9 shows another view of a sound absorber unit in accordance with an embodiment of the disclosure. The left end (in the photo) is the end created when the pocket abuts the loom selvage.

FIG. 10 shows the one of the edges that is the working end of a sound absorber unit in accordance with an embodiment of the disclosure. It can be seen that the seam appears to be sewn, but in this embodiment, it is actually an edge formed by folding the fabric and gluing it together.

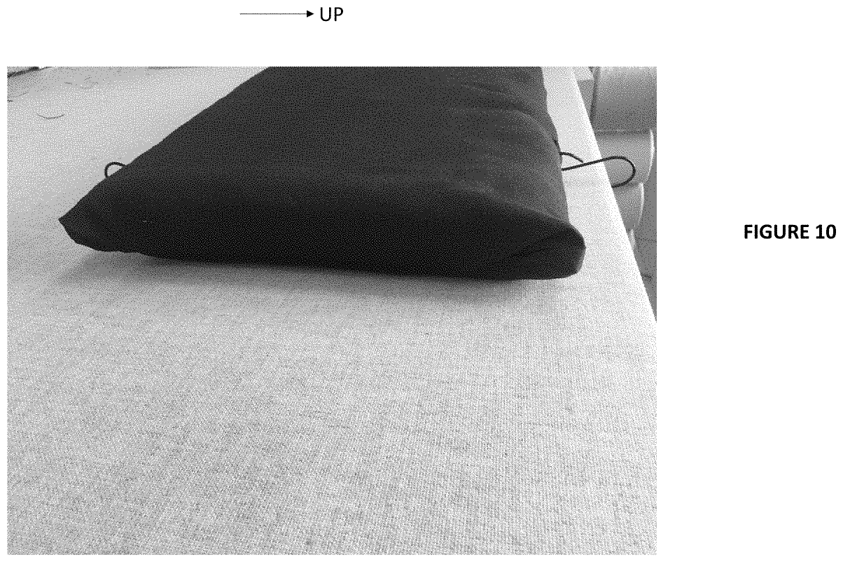

### DETAILED DESCRIPTION

The following description recites various aspects and embodiments of the disclosure. No particular embodiment is intended to define the scope of the disclosure. Rather, the embodiments merely provide non-limiting examples. The description is to be read from the perspective of one of ordinary skill in the art; therefore, information well known to the skilled artisan is not necessarily included.

Definitions

The present disclosure now will be described more fully hereinafter. The disclosure may be embodied in many different forms and should not be construed as limited to the aspects set forth herein; rather, these aspects are provided so that this disclosure will satisfy applicable legal requirements. Unless defined otherwise, all technical and scientific terms used herein have the same meaning as is commonly understood by one of ordinary skill in the art to which this disclosure belongs.

When introducing elements of the present disclosure or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements. It is understood that aspects and embodiments of the disclosure described herein include “consisting” and/or “consisting essentially of” aspects and embodiments.

The term “and/or” when used in a list of two or more items, means that any one of the listed items can be employed by itself or in combination with any one or more of the listed items. For example, the expression “A and/or B” is intended to mean either or both of A and B, i.e. A alone, B alone or A and B in combination. The expression “A, B and/or C” is intended to mean A alone, B alone, C alone, A and B in combination, A and C in combination, B and C in combination or A, B, and C in combination.

Various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used herein a “protective material” includes anti-ballistic and/or explosion shield materials. Anti-ballistic materials are generally composites designed to stop bullets, and explosion shields are generally composites designed to stop shrapnel and heat from explosions. Such materials may contain a variety of materials and mixtures including aramids like poly-paraphenylene terephthalamide (e.g., KEVLAR® or NOMEX®), ultra-high molecular weight polyester, carbon fibers, polycarbonate (e.g., LEXAN®), titanium, or other metals and/or metal fibers.

As used herein, the term “selvage” as used herein is a tightly woven edge on a fabric.

As used herein, the term “working end” as used herein, is the edge of the weave which is cut to expose pockets in the encasement fabric as woven.

As used herein, the term “structural weave” is used herein is a tightly woven fabric. As used herein, a structural weave seam is woven so as to not include a pocket within.

As used herein, a “pocket” is a discrete and defined inner volume within the unit.

As used herein, a “weave” is a defined tightness of how a fabric is woven. Weaves may be distinguished by the nature of the yarn as well as the tightness of the weave in either direction (weft or warp). As used herein, weave or weaving or woven does not include sewing or sewn fabric.

As used herein, “sound/protective absorber material” is used to denote sound absorber material or protective absorber material.

As used herein an “encasement material” is a material used to encase the sound and/or protective absorber material. The encasement material may be cloth or a fabric or other pliable but supportive material.

Sound And Protective Absorber Units

In one embodiment, disclosed is a sound absorber unit comprising a sound absorber material that is encased in an encasement material. In another embodiment, disclosed is a protective absorber unit comprising a protecitve absorber material that is encased in an encasement material.

The emplacement material may be a cloth. In an embodiment, the cloth is a fabric, such as the type of fabric used on furniture or as a wall hanging. The cloth or fabric may be woven.

In certain embodiments, the sound absorber material may be mineral wool, polymer foam, fiberglass, or any other material that can be used to absorb sound. In certain embodiments, the fabric is acoustically transparent so that sound does not bounce off the fabric. In an embodiment, sound passes through the fabric and into the interior of the hanging to be absorbed by the sound absorber material. In an embodiment, the protective absorber material may be an anti-ballistic material or an explosion shield material.

In an embodiment, the encasement is woven with pockets to house support rods and the sound absorbing or protective absorbing material. In an embodiment, the sound/protective absorber unit comprises a woven fabric that in itself may contribute to absorbing the sound or to protection from a ballistic impingement or an explosion.

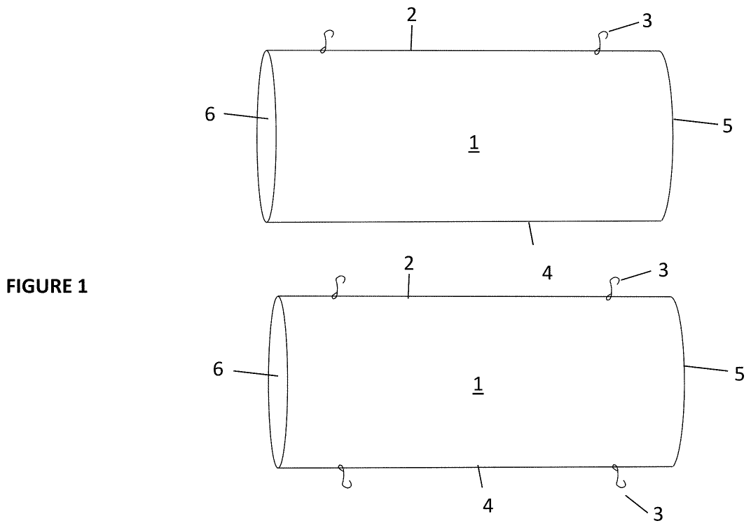

FIG. 1 shows two different embodiments of a sound absorber or protective absorber unit 1 of the disclosure made to function as a hanging. One of the units has hooks 3 only on the upper edge 2, whereas the other unit has hooks on both the upper 2 and lower edge 4. One side edge 5 of the unit is generally a tight seam created by folding of the unit from inside out to right side out. The other side edge of the unit (i.e., the working end) 6 may have a distinct surface area as shown in FIG. 1 or may be sealed to be a single seam.

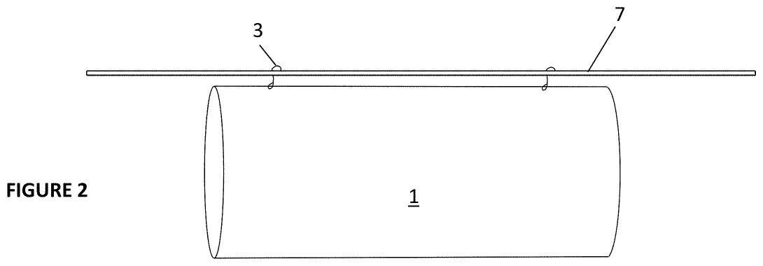

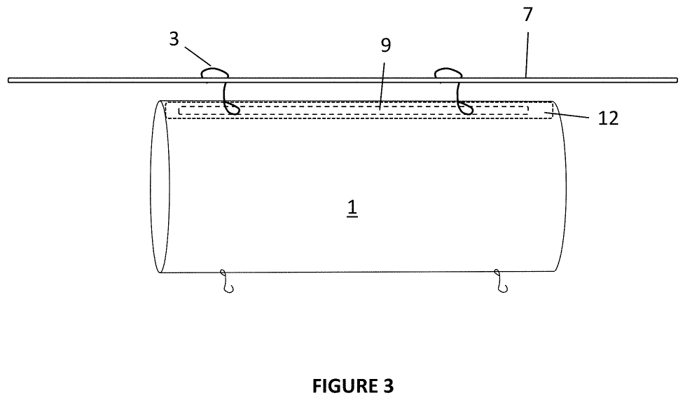

Internal support structures, such as rods or other rigid units, may be inserted within the unit. Such support structures can be used to maintain the shape of the unit and the position of the sound and/or protective absorber material within the unit. Such support structures may also support hooks or other fasteners used to hang the sound and/or protective absorber unit. FIG. 2 shows an embodiment of a sound absorber unit 1 hanging via hooks 3 attached to the unit from an external support 7, and FIG. 3 shows embodiment of a sound absorber unit 2 with an internal pocket 12 housing an internal support structure 9 that engages the hooks 3 which allow for the unit to be hung from an external support structure 7.

It will be envisioned that a protective unit of the disclosure may have similar components as the sound absorber unit. For example, such protective units may be hung in buildings to protect inhabitants from explosions. Or, the protective unit may be formulated as a clothing item (e.g., a vest) and as such may not need hooks or other elements for hanging.

The sound and/or protective absorber unit may be any size. The only limit on size is the strength of the fixture to which the unit is being hung and the size of the space where the unit is to be placed. In an embodiment, the exterior surface area is maximized so as to maximize the ability of the internally positioned sound absorber material to absorb sound waves and/or to shield from an explosion. For example, the sound and/or protective absorber unit may range from about 0.5 foot by 1 foot up to about 4 feet by 20 feet and all subranges in between 0.5 foot by 20 feet. The unit may, in certain embodiments, be rectangular. In one embodiment, the sound absorber unit is about 18 inches in height and 48 inches long (across). As used herein, the height may correspond to the vertical dimension of the sound absorber unit such that the unit is longer along the horizontal edge than the vertical edge (e.g., FIG. 1).

Also, the sound and/or protective absorber unit may be a variety of thicknesses. Generally, the thickness will comprise the thickness of the sound absorber or protective absorber material and/or any support structures inserted in the unit and the encasment material used to enclose the sound/protective absorber material. In one embodiment, the sound and/or protective absorber unit may range from about 1-60, or 1-50, or 1-40, or 1-30, or 1-20, or 1-10, or 1-5 inches in thickness.

In certain embodiments, the sound absorber material and/or protective absorber material is such that it will retain its general shape regardless of whether the hanging is vertical or horizontal. In an embodiment, the sound/protective absorber material is encased within a pocket(s) or weave(s) that may be woven into the unit.

Methods of Making

Also disclosed is a method of making a sound and/or protective absorber unit. In certain embodiments, the unit may be manufactured inexpensively without extensive, or any, sewing.

In certain embodiments the method of making comprises the steps of: (i), weaving an encasement material for the unit to include at least one pocket for insertion of the sound absorber material and/or protective material and optionally a second inner pocket for emplacement of a support structure. In an embodiment, at least two edges of the pockets may be bounded by a structural weave. In an embodiment, the encasement material is woven with the inside surfaces facing outward.

The method may further include cutting one edge of the encasement material to allow access to the first inner pocket and the optional at least one second inner pocket In certain embodiments, the encasment material is woven as multiple units. In such an embodiment, the method may comprise cutting the encasement material along the longitudinal axis of the structural weave to separate one unit from the other units.

Next, the method may comprise reversing the encasement material so that the outside surfaces are facing outwards and the inner edge of the innermost seams of structural weave becomes the outer edges (e.g., top and bottom) of the unit. Next the method may comprise emplacing the sound absorber or protective material in the first pocket, and optionally, emplacing at least one support structure in the optional at least one second inner pocket. At this point, the unit maybe closed by sealing the open end, i.e., the working end of the encasement material, such that the at least one support structure and the sound absorbing or protective material is completely enclosed in the first and the at least one second inner pocket, respectively. In certain embodiments where the unit is a hanging, at least one hanging element (e.g. hook or other hanging element known in the art) may be inserted through encasement in such a manner as to encircle at least in part the support structure.

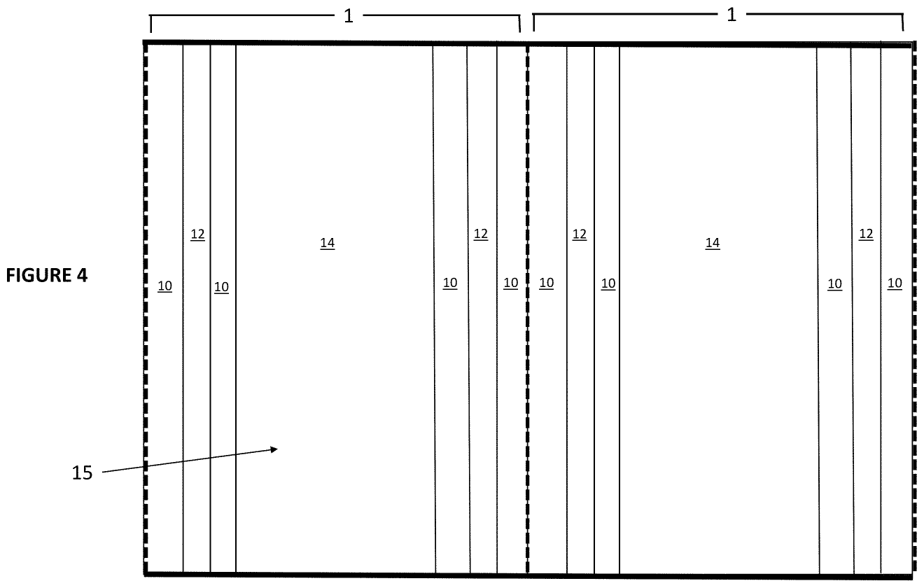

For example, FIG. 4 shows an embodiment of encasement material (e.g., fabric or cloth) woven as two units 1. In the embodiment shown in FIG. 4, the inner surfaces 15 are exposed (i.e., facing outward). In an embodiment, the encasement material is woven with pockets. Thus, the encasement material may configured to comprise two layers that are sealed together along various longitudinal seams of structural weave 10 so as to form boundaries for the various inner pockets. In an embodiment, the larger pockets 14 are sized to be filled with the protective or sound absorbing material. The smaller pockets 12 are optional, and may be sized to house a support structure (e.g., a rod). For example, in some embodiments the larger pocket may comprise greater than 50% of the inner volume of the final unit.

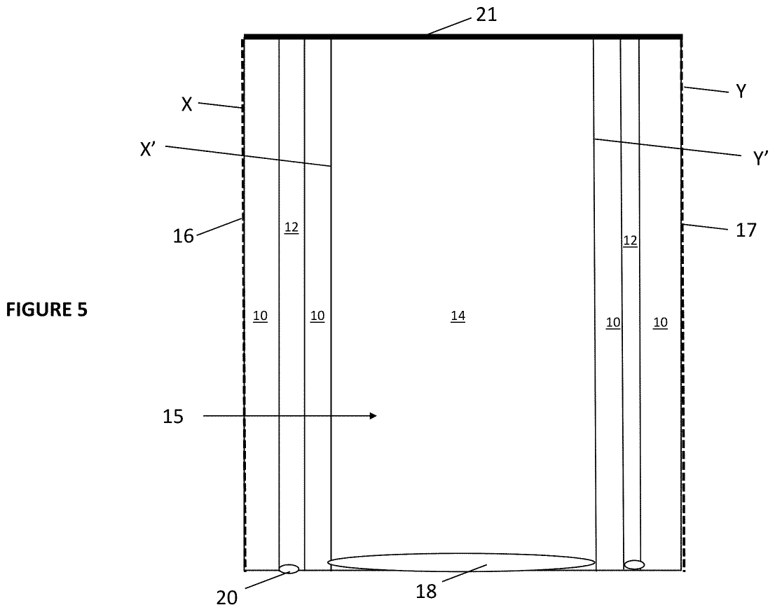

FIG. 5 shows an embodiment of the encasement material of FIG. 4 that has been cut 16, 17 within two of the structural weave seams 10 to provide a single unit 1 having openings 18, 20 to expose the pockets 14 and 12, respectively, for the insertion of sound/protective absorber material and inner support structures. In the embodiment shown in the FIG. 5, the inner surfaces 15 are still exposed (i.e., facing outward). The outer seam of the outermost structural weave is bounded by cut edges X, Y. The inner seam of the innermost structural weave is bounded by inner edge X′, Y′ that abuts the large inner pocket 14.

It will be appreciated that while the embodiments depicted show structural weaves emplaced to create two smaller inner pockets for support structures and one larger pocket for the sound/protective absorbing material per unit, the unit could be configured with additional pockets bounded by additional structural weave seams to allow for multiple pockets for emplacement of sound/protective absorber material and/or support structures.

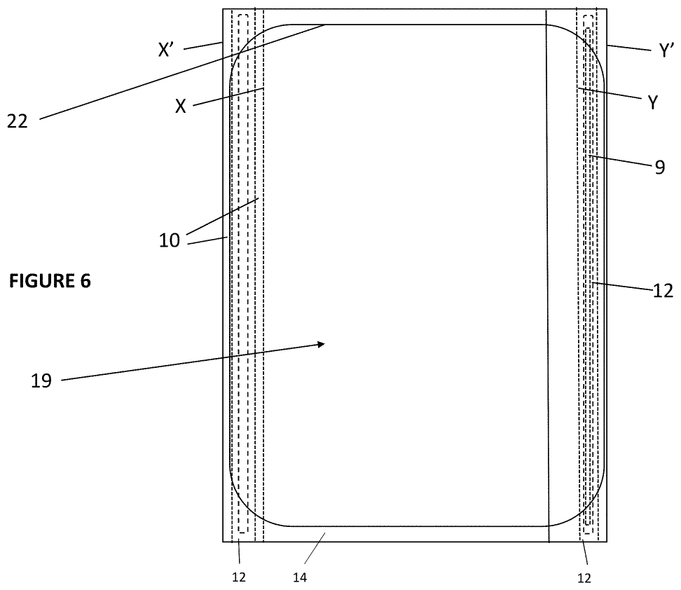

As shown in FIG. 6, at this point, the encasement material may be turned “right side out” such that the outer surface 19 of the encasement fabric faces outward. The results in the cut edges X, Y of the structural weave to be internal to the previously inner-most edges X′,Y′. In this way the previoulsly inner-most edges of the structural weave (i.e., the edges abutting the larger pocket 14) form a smooth seal that becomes the outer edge 2,4 (FIG. 1) of the unit. FIG. 6 shows the unit of FIG. 5 reversed to have the outside surface 19 facing outward, the inner pockets filled with sound absorbing material 22 and one support structure 9 and the edges closed.

Similarly, in the embodiment where the encasement fabric is woven to comprise a structural weave or selvage on the edge 21 (or both edges) (FIG.5) perpendicular to the structural weave seams 10 that are parallel to the longitudinal axis of inner pockets 12, folding of the material so that it is right side out will result in the selvage being folded within the unit such that a clean edge 5 (FIG. 1) is formed. Selvage on the edge that is cut to exposed the pockets can also be sealed to form a clean edge or a side having a surface area 6 (FIG. 1).

In certain embodiments, the encasement material is a cloth produced by weaving or knitting textile yarns. Or, the fabric may be made of a non-woven material. The fibers may be natural (e.g., from a plant) or synthetic (man-made) or a mixture of both.

For example, a unit with the dimensions of about 3 inches thick, 18 inches in height and 48 inches across, may comprise a large pocket that houses sound absorber material and that is roughly 54 inches by 20 inches. The unit may also include a smaller (narrow) pocket or a plurality of smaller pockets woven along what will become the top and bottom of the big pocket and/or the top and bottom seam of the unit. These smaller pockets (e.g., about 1 inch by 48 inches in diameter) are used to house support structures. Such support structures may be rods made of supportive material such as steel or aluminum. Or such support structures may comprise a lighter material such as fairly rigid plastic.

As described herein, the fabric used as encasement material may be manufactured as a long strip of multiple units arranged along the length of the strip. Once the fabric is woven, it may be cut into single units by cutting the unit from a longer roll of fabric. Alter the unit is folded to be right side out, the sound or protective absorber material, such as anti-ballistic material or fire proof mineral wool around 3 inches thick, 18 inches across, and 48 inches long may then be positioned inside the fabric. In an embodiment, the sound/protective absorber material is inserted into the large inner pocket that has been woven into the unit. The sound/protective absorber material may be compressed into a smaller volume and then inserted into the pocket where it can than expand and fill out the pocket volume. The support rods (inserted into the smaller pockets) provide added dimensional stability and may also be used to anchor for “S” hooks or other hanging elements use to attach the hanging to the fixture of interest. Prior to insertion of the sound/protective absorber material, the entire unit is turned inside out. In this way, the pockets are on the inside of the unit and each of the edges except the working end are smooth seams. After insertion of the sound/protective absorber material and, if needed, support rods, the working end is sealed (e.g., glue, sewing). At this point, fasteners such as, but not limited to, hooks may be inserted into the upper seam and/or the lower seam.

Methods of Use

Also disclosed is a method for reducing sound in a defined space by hanging a fabric encased sound absorber from the ceiling or on the walls. The sound absorber may, in certain embodiments, be hung from the ceiling of a building (e.g., on a support rod or fixture).

Also disclosed is a method for protecting against a ballistic explosion or gunfire in a defined space by hanging a protective absorber unit of any of the previous or subsequent embodiments in the space.

In an embodiment, the disclosed sound absorber hangings are effective because they are relatively large, thick, and many can be hung inconspicuously from a ceiling. In certain embodiments, a plurality of sound absorbers may be hung in rows or in a grid pattern from the ceiling. In certain embodiments, the sound absorber hanging may be positioned so as to hang down around 18 inches. Or, two absorbers may be vertically connected so as to comprise a 36 inch hanging. In certain embodiments, the sound absorber hanging may be positioned horizontally rather than vertically.

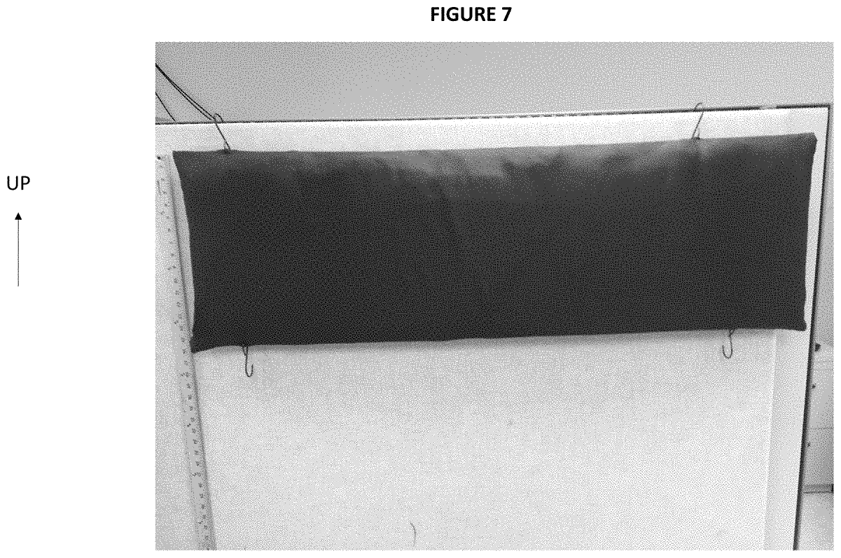

FIG. 7 shows a sound absorber hanging of the disclosure in a hanging position. It can be seen that there are fasteners (i.e., hooks) positioned along the top edge. Although hanging from a display board in the photo, the unit may be hung from a ceiling or other building structure. It can be seen that in certain embodiments, fasteners may be hung from the lower edge of the unit to facilitate hanging additional units, as for example from a high ceiling.

### EXAMPLE

### Example 1

### Manufacturing a Sound Absorber Hanging

Polyester fabric was cut with a hot knife which also melted the edges and prevented fraying. One of the fabric selvages was cut off with scissors to open the pockets. The large pocket was turned inside out so the fabric's natural loom selvage became one clean end of the encasement. The rough look of the selvage itself was then out of view because it was inside of the encasement.

At this point, two small pockets for the support rods were inside of the large pocket encasement, and a rod was inserted into each of the pockets. Holes for “S” hooks were then melted with a hot soldering iron on the inside of the steel rod. The “S” hooks were installed and then the mineral wool was compressed and inserted into the pocket using standard tools and methods used to stuff foam into furniture cushions. The working end (i.e., the end that facilitated insertion of the sound absorber material) was then sealed. Such sealing can be done with glue, staples, sewing, or any other standard method known in the art.

An example of such a sound absorber hanging positioned on a display board for illustrative purposes is shown in FIG. 7. The sound absorbing unit shown in FIG. 7 has hooks on the upper edge and the lower edge. For example, the hanging may be positioned on a rod or other structure that is attached to a ceiling and then another unit may be hung from the bottom edge of the first unit. For example, a rod may be inserted through the hooks on the lower edge to allow for the hanging of a second unit from the rod. Or, hooks on the upper edge of the lower unit may be inserted through the hooks on the lower edge of the upper unit. In this way, multiple units may be strung together, essentially providing a wall of sound absorbing units.

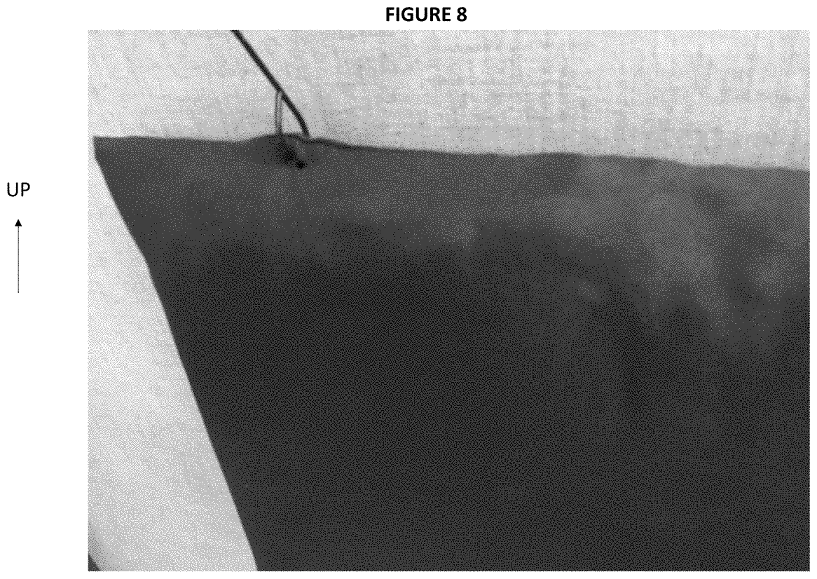

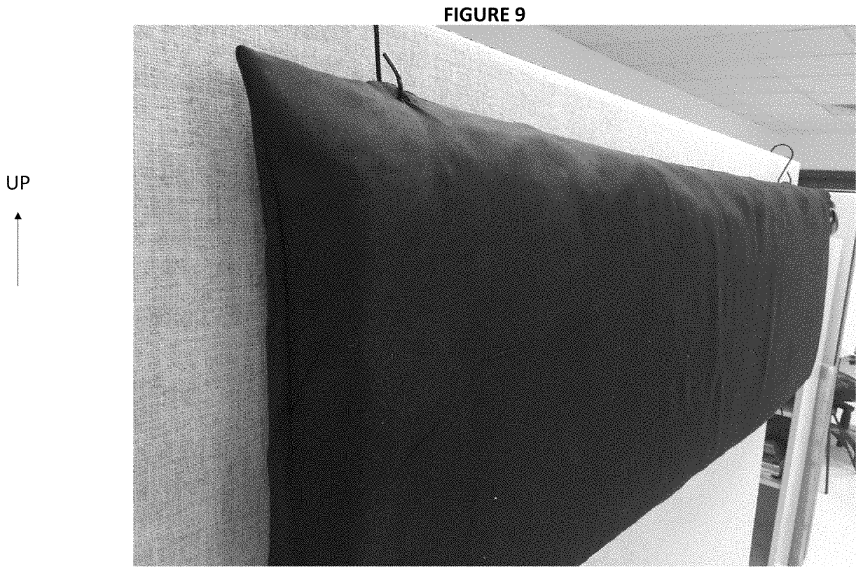

FIGS. 8 and 9 show other views of the sound absorbers made as disclosed herein. FIG. 8 shows a close up view of a fastener that is inserted into the sound absorber and supported by an internal rod that runs through the width of the sound absorber along the upper seam. The sound absorber hanging of FIGS. 7-9 is about 3 inches thick.

### Example 2

### Embodiments

The disclosure may be better understood by referring to the following non-limiting embodiments.
A1. A sound absorber unit comprising: a sound absorber material encased in an encasement material woven to comprise at least one inner pocket for emplacement of the sound absorber material and optionally, at least one second inner pocket for insertion of a support structure.
A2. The unit of any of the prior or subsequent embodiments, wherein the encasement material is cloth or fabric.
A3. The unit of any of the prior or subsequent embodiments, wherein the sound absorber material comprises mineral wool, polymer foam, fiberglass, or any other material that can be used to absorb sound.
A4. The unit of any of the prior or subsequent embodiments, wherein the cloth is a fabric, such as the type of fabric used on furniture or as a wall hanging.
A5. The unit of any of the prior or subsequent embodiments, further comprising a support structure inserted within the second inner pocket.
A6. The unit of any of the prior or subsequent embodiments, wherein the support structure comprises a rod.
A7. The unit of any of the prior or subsequent embodiments, wherein the support structure maintains the shape of the unit and the position of the sound absorber material within the unit.
B1. A protective absorber unit comprising: a protective absorber material encased in an encasement material woven to comprise at least one inner pocket for emplacement of the protective absorber material and optionally, at least one second inner pocket for insertion of a support structure.
B2. The unit of any of the prior or subsequent embodiments, wherein the encasement material is cloth or fabric.
B3. The unit of any of the prior or subsequent embodiments, wherein the protective absorber material comprises aramids like poly-paraphenylene terephthalamide (e.g., KEVLAR® or) NOMEX®), ultra-high molecular weight polyester, carbon fibers, polycarbonate (e.g.,) LEXAN®), titanium, or other metals and/or metal fibers.
B4. The unit of any of the prior or subsequent embodiments, wherein the cloth is a fabric.
B5. The unit of any of the prior or subsequent embodiments, further comprising a support structure inserted within the second inner pocket.
B6. The unit of any of the prior or subsequent embodiments, wherein the support structure comprises a rod.
B7. The unit of any of the prior or subsequent embodiments, wherein the support structure maintains the shape of the unit and the position of the sound absorber material within the unit.
C1. A method for making a sound absorber or a protective absorber unit comprising:

(a) obtaining a sound absorber or a protective absorber material;

(b) encasing the sound absorber material or the protective absorber material in an encasement material such that the sound absorber material or the protective absorber material is substantially evenly distributed within the inner volume of the encasement cloth; and

(c) closing any openings in the encasement material such that the sound absorber material is completely encased in the encasement material.
C2. The method of any of the prior or subsequent embodiments, wherein the encasement material is configured to comprise two layers that are sealed together along each edge and that are configured to form a first inner pocket and optionally, at least one second inner pocket suitable for insertion of at least one support structure.
C3. The method of any of the prior or subsequent embodiments, wherein the first inner pocket comprises greater than 50% of the inner volume.
C4. The method of any of the prior or subsequent embodiments, comprising opening one of the sealed edges to form a working end for insertion of the sound absorber material and optionally, the at least one support structure.
C5. The method of any of the prior or subsequent embodiments, comprising turning the encasement material inside out such that three edges abutting the large inner pocket comprise seams that are folded inside of the unit and the fourth edge comprises an open working end.
C6. The method of any of the prior or subsequent embodiments, comprising inserting the sound absorber material or the protective absorber material into the large pocket via the working end.
C7. The method of any of the prior or subsequent embodiments, comprising inserting the at least one support structure within the at least one second pocket via the working end.
C8. The method of any of the prior or subsequent embodiments, wherein the at least one second pocket is configured such that when inserted into pocket, the support structure extends along a horizontal edge of the unit.
C9. The method of any of the prior or subsequent embodiments, comprising sealing the working end of the unit.
C10. The method of any of the prior or subsequent embodiments, comprising the steps of: (i) weaving an encasement material with a first pocket for insertion of the sound absorber or protective absorber material and an second optional inner pocket for insertion of a support structure and having the inside surfaces facing outward; (ii) cutting one edge of the encasement material to allow access to the first inner pocket and the optional at least one second inner pocket; (iii) reversing the encasement material so that the outside surfaces are facing out; (iv) emplacing the sound absorber or protective material in the first pocket; (v) optionally, emplacing at least one support structure in the at least one second inner pocket; and (vi) sealing the open end of the encasement material such that the at least one support structure and the sound absorbing material or protective material is completely enclosed in the first inner pocket and optionally the at least one second inner pocket, respectively.
C11. The method of any of the prior or subsequent embodiments, comprising inserting at least one hanging element through encasement material in such a manner as to encircle at least in part the support structure.
C12. The method of any of the prior or subsequent embodiments, wherein the encasement material is made with minimal or no sewing such that a loom makes all the pockets, structural weave and edges.
D1. A method for reducing sound in a defined space by hanging a sound absorber unit of any of the previous or subsequent embodiments in the space.
D2. The method of any of the prior or subsequent embodiments, wherein the sound absorber unit is hung from the ceiling or on the walls.
D3. The method of any of the prior or subsequent embodiments, wherein the sound absorber unit is hung such that the longest dimension of the hanging is horizontal.
E1. A method for protecting against an explosion or other ballistic event in a defined space by hanging a protective absorber unit of any of the previous or subsequent embodiments in the space.
E2. The method of any of the prior or subsequent embodiments, wherein the protective absorber unit is hung from the ceiling or on the walls.
E3. The method of any of the prior or subsequent embodiments, wherein the protective absorber unit is hung such that the longest dimension of the hanging is horizontal.

That which is claimed is:

1. A sound absorber unit comprising: a sound absorber material encased in an encasement material woven to comprise at least one inner pocket for emplacement of the sound absorber material and optionally, at least one second inner pocket for insertion of a support structure.

2. The unit of claim 1, wherein the encasement material is cloth or fabric.

3. The unit claim 1, wherein the sound absorber material comprises at least one of mineral wool, polymer foam, or fiberglass.

4. The unit of claim 1, further comprising a support structure inserted within the second inner pocket.

5. The unit of claim 4, wherein the support structure comprises a rod.

6. The unit of claim 4, wherein the support structure maintains the shape of the unit and the position of the sound absorber material within the unit.

7. A protective absorber unit comprising: a protective absorber material encased in an encasement material woven to comprise at least one inner pocket for emplacement of the protective absorber material and optionally, at least one second inner pocket for insertion of a support structure

8. The unit of claim 7, wherein the protective absorber material comprises at least one of an aramid, an ultra-high molecular weight polyester, carbon fibers, polycarbonate, titanium, or other metals and/or metal fibers.

9. The unit of claim 7, comprising a support structure inserted within the second inner pocket.

10. A method for making a sound absorber or a protective absorber unit comprising:
(a) obtaining a sound absorber or a protective absorber material;
(b) encasing the sound absorber material or the protective absorber material in an encasement material such that the sound absorber material or the protective absorber material is substantially evenly distributed within the inner volume of the encasement cloth; and
(c) closing any openings in the encasement material such that the sound absorber material is completely encased in the encasement material.

11. The method of claim 10, wherein the encasement material is configured to comprise two layers that are sealed together along each edge and that are configured to form a first inner pocket and optionally, at least one second inner pocket suitable for insertion of at least one support structure.

12. The method of claim 11, wherein the first inner pocket comprises greater than 50% of the inner volume.

13. The method of claim 11, further comprising opening one of the sealed edges to form a working end for insertion of the sound absorber material and optionally, the at least one support structure.

14. The method of claim 13, further comprising turning the encasement material inside out such that three edges abutting the large inner pocket comprise seams that are folded inside of the unit and the fourth edge comprises an open working end.

15. The method of claim 14, further comprising inserting the sound absorber material or the protective absorber material into the large pocket via the working end.

16. The method of claim 14, further comprising inserting the at least one support structure into the at least one second pocket via the working end.

17. The method claim 11, wherein the at least one second pocket is configured such that when inserted into pocket, the support structure extends along a horizontal edge of the unit.

18. The method of claim 14, further comprising sealing the working end of the unit.

19. The method of claim 10, comprising inserting at least one hanging element through encasement material in such a manner as to encircle at least in part the support structure.

20. The method of claim 10, wherein the encasement material is made with minimal or no sewing such that a loom makes all the pockets, structural weave and edges.

21. A method for making a sound absorber or a protective absorber unit comprising the steps of:
(i) weaving an encasement material with a first pocket for insertion of the sound absorber or protective absorber material and an second optional inner pocket for insertion of a support structure and having the inside surfaces facing outward;
(ii) cutting one edge of the encasement material to allow access to the first inner pocket and the optional at least one second inner pocket;
(iii) reversing the encasement material so that the outside surfaces are facing out;
(iv) emplacing the sound absorber or protective material in the first pocket;
(v) optionally, emplacing at least one support structure in the at least one second inner pocket; and
(vi) sealing the open end of the encasement material such that the at least one support structure and the sound absorbing material or protective material is completely enclosed in the first inner pocket and optionally the at least one second inner pocket, respectively.

22. The method of claim 21, comprising inserting at least one hanging element through encasement material in such a manner as to encircle at least in part the support structure.

23. A method for reducing sound in a defined space comprising: hanging a sound absorber unit comprising a sound absorber material encased in an encasement material woven to comprise at least one inner pocket for emplacement of the sound absorber material and optionally, at least one second inner pocket for insertion of a support structure in the space.

24. A method for protecting against an explosion or other ballistic event in a defined space comprising: hanging a protective absorber unit comprising a protective absorber material encased in an encasement material woven to comprise at least one inner pocket for emplacement of the protective absorber material and optionally, at least one second inner pocket for insertion of a support structure in the space.
